(19) United States
(12) Patent Application Publication
(10) Pub. No.: US 2012/0148722 A1
(43) Pub. Date: Jun. 14, 2012

(54) ACIDIC OIL-IN-WATER TYPE EMULSIFIED SEASONING AND THE METHOD FOR MANUFACTURING THE SAME, AND SALAD COMPRISING THE ACIDIC OIL-IN-WATER TYPE EMULSIFIED SEASONING

(75) Inventors: Satoshi Teraoka, Tokyo (JP); Tomofumi Kimura, Tokyo (JP); Masahiro Ariizumi, Tokyo (JP); Kaori Oguchi, Tokyo (JP)

(73) Assignee: KEWPIE CORPORATION, Tokyo (JP)

(21) Appl. No.: 13/390,906

(22) PCT Filed: Aug. 10, 2010
(86) PCT No.: PCT/JP2010/063540

§ 371 Date: Feb. 16, 2012

(30) Foreign Application Priority Data
Aug. 19, 2009 (JP) 2009-190277

(51) Int. Cl. A23L 1/24; A23D 7/005

(52) U.S. Cl. 426/605; 426/602

(57) ABSTRACT

Provided an acidic oil-in-water type emulsified seasoning comprising a cross-linked starch, the content of oils and fats is 10 to 70 mass %, the viscosity is 20,000 to 1,000,000 mPa·s, a first peak is present in the range of 0.5 to 5 micrometers and a second peak is present in the range of 20 to 80 micrometers in a particle size distribution of the acidic oil-in-water type emulsified seasoning measured by using a laser diffraction particle size analyzer, and the cross-linked starch has the following characteristics:
the viscosity of a mixture of the cross-linked starch and water prepared under the following condition is 120 to 20,000 mPa·s; and
the average particle diameter of the cross-linked starch being present in the mixture is 20 to 40 micrometers.

Condition: a mixture of the cross-linked starch and water comprising 8 mass % of the cross-linked starch is heated up to 90° C., and then is maintained at 90° C. for 5 minutes, and then is cooled to 20° C., and then is stirred with a homomixer at 10,000 rpm for 5 minutes.

### TECHNICAL FIELD

The invention relates to an acidic oil-in-water type emulsified seasoning and the method for manufacturing the same, and salad comprising the acidic oil-in-water type emulsified seasoning.

### BACKGROUND ART

An acidic oil-in-water type emulsified seasoning such as mayonnaise and dressing is a type of widely popular seasonings in dietary life, and salad is a typical food using the acidic oil-in-water type emulsified seasoning. Salad can be classified to potato salad, vegetable salad, pasta salad, egg salad, fruit salad, for example, based on the main foodstuff used. Salad with the acidic oil-in-water type emulsified seasoning is generally manufactured by mixing foodstuffs and the acidic oil-in-water type emulsified seasoning.

There has been a problem with vegetable salad and fruit salad, since water separates from foodstuffs such as vegetable or fruit as time passes after the production of the salad, and therefore the appearance of the salad deteriorates and it is difficult to maintain the taste of fresh salad.

Also, JP-B-7-112414 discloses a salad dressing using a gelatinized starch. However, in JP-B-7-112414, there is no description the salad dressing is effective for preventing water separation from foodstuffs such as vegetables or fruits when producing salad such as vegetable salad or fruit salad described above.

### DISCLOSURE OF THE INVENTION

### Problems to be Solved by the Invention

The invention provides an acidic oil-in-water type emulsified seasoning which can effectively prevent water separation (syneresis) from foodstuffs, and the method for manufacturing the same, and salad comprising the acidic oil-in-water type emulsified seasoning.

### Means for Solving the Problems

According to one aspect of the invention, there is provided an acidic oil-in-water type emulsified seasoning comprising a cross-linked starch, the content of oils and fats is 10 to 70 mass %, the viscosity is 20,000 to 1,000,000 mPa·s, a first peak is present in the range of 0.5 to 5 micrometers and a second peak is present in the range of 20 to 80 micrometers in a particle size distribution of the acidic oil-in-water type emulsified seasoning measured by using a laser diffraction particle size analyzer, and the cross-linked starch has the following characteristics:

the viscosity of a mixture of the cross-linked starch and water prepared under the following condition is 120 to 20,000 mPa·s; and the average particle diameter of the cross-linked starch being present in the mixture is 20 to 40 micrometers.

Condition: a mixture of the cross-linked starch and water comprising 8 mass % of the cross-linked starch is heated up to 90° C., and then is maintained at 90° C. for 5 minutes, and then is cooled to 20° C., and then is stirred with a homomixer at 10,000 rpm for 5 minutes.

In the above-mentioned acidic oil-in-water type emulsified seasoning, the first peak may be present in the range of 1 to 3 micrometers.

In the above-mentioned acidic oil-in-water type emulsified seasoning, the content of oils and fats is 10 to 70 mass %, the viscosity is 20,000 to 1,000,000 mPa·s, a first peak is present in the range of 0.5 to 5 micrometers and a second peak is present in the range of 20 to 80 micrometers in a particle size distribution of the acidic oil-in-water type emulsified seasoning measured by using a laser diffraction particle size analyzer, and the cross-linked starch may have a shear resistance of 0.7 to 0.9 calculated from the following procedures (1) to (3).

procedure (1): a mixture of the cross-linked starch and water comprising 8 mass % of the cross-linked starch is heated up to 90° C., and then is maintained at 90° C. for 5 minutes, and then is cooled to 20° C., and then is stirred with a vertical mixer (which a wire whip is attached to) on scale 6 for 3 minutes to obtain a resulting mixture, and a volume average particle diameter A of the cross-linked starch in the resulting mixture is measured by laser diffraction particle size distribution analysis.

procedure (2): the mixture of the cross-linked starch and water comprising 8 mass % of the cross-linked starch obtained by procedure (1) is stirred with a homomixer at 10,000 rpm for 5 minutes to obtain a resulting mixture, and a volume average particle diameter B of the cross-linked starch in the resulting mixture is measured by laser diffraction particle size distribution analysis.

procedure (3): A shear resistance is calculated from the following calculating formula.

shear resistance=B/A

In the above-mentioned acidic oil-in-water type emulsified seasoning, the first peak may be present in the range of 1 to 3 micrometers.

According to another aspect of the invention, there is provided a salad comprising the above-mentioned acidic oil-in-water type emulsified seasoning and at least one of a vegetable and a fruit.

According to further another aspect of the invention, there is provided a method for manufacturing the above-mentioned acidic oil-in-water type emulsified seasoning comprising mixing a water phase which comprises egg yolk and the cross-linked starch and an oil phase.

### EFFECT OF THE INVENTION

According to the acidic oil-in-water type emulsified seasoning comprising the cross-linked starch, the content of oils and fats is 10 to 70 mass %, the viscosity is 20,000 to 1,000,000 mPa·s, the first peak is present in the range of 0.5 to 5 micrometers and the second peak is present in the range of 20 to 80 micrometers in the particle size distribution measured by using a laser diffraction particle size analyzer, and the cross-linked starch has the following characteristics: the viscosity of the mixture of the cross-linked starch and water prepared under the following condition is 120 to 20,000 mPa·s; and the average particle diameter of the cross-linked starch being present in the mixture is 20 to 40 micrometers. Water separation from foodstuffs can be effectively prevented and good texture can be provided by mixing the above-mentioned cross-linked starch into salad. Also, the above-mentioned acidic oil-in-water type emulsified seasoning has a sense of volume and good melt-in-the-mouth.

### BRIEF DESCRIPTION OF THE DRAWINGS

FIG. 1 is a graph representing particle size distributions of the semi-solid salad dressings manufactured in Example 1 and Comparative Example 3, respectively.

### BEST MODE FOR CARRYING OUT THE INVENTION

An acidic oil-in-water type emulsified seasoning and the method for manufacturing the same, and salad comprising the acidic oil-in-water type emulsified seasoning according to embodiments of the invention are described in detail below. Furthermore, “%” used in the invention refers to “mass %”.

### 1. Acidic Oil-in-Water Type Emulsified Seasoning

An acidic oil-in-water type emulsified seasoning according to one embodiment of the invention comprises a cross-linked starch, the content of oils and fats is 10 to 70 mass %, the viscosity is 20,000 to 1,000,000 mPa·s, a first peak is present in the range of 0.5 to 5 micrometers and a second peak is present in the range of 20 to 80 micrometers in a particle size distribution of the acidic oil-in-water type emulsified seasoning measured by using a laser diffraction particle size analyzer, and the cross-linked starch has the following characteristics: the viscosity of a mixture of the cross-linked starch and water prepared under the following condition is 120 to 20,000 mPa·s; and the average particle diameter of the cross-linked starch being present in the mixture is 20 to 40 micrometers.

Furthermore, the above-mentioned acidic oil-in-water type emulsified seasoning according to this embodiment is an acid seasoning (having pH of 4.6 or less) in which edible oils and fats are dispersed as oil droplets nearly homogeneously in aqueous phase to maintain an oil-in-water type emulsion state.

### 1.1. Cross-Linked Starch

The acidic oil-in-water type emulsified seasoning according to this embodiment may further comprise cross-linked starch. In the acidic oil-in-water type emulsified seasoning according to this embodiment, at least apart of the cross-linked starch is preferably present without dissolving, more specifically, the cross-linked starch may be present as particles in a swelling (water-absorbing) state.

The cross-linked starch used in the acidic oil-in-water type emulsified seasoning according to this embodiment is obtained by cross-linking some of hydroxyl groups in a starch molecule, and cross-linking methods are acetylated adipate cross-linking, acetylated phosphate cross-linking, or the like. Starch, which is a raw material of the cross-linked starch, is not particularly limited based on its type, but may be for example, potato starch, cornstarch (for example, cornstarch originating from sweet corn, cornstarch originating from dent corn, cornstarch originating from waxy corn), tapioca starch, sago starch, ocarina starch, wheat starch, or rice starch, in particular, cornstarch or tapioca starch is preferable because these particle diameters are generally arranged in the range of about 20 to 40 micrometers, and therefore the cross-linked starch having the average particle diameter described later can be easily prepared.

The average particle diameter of the cross-linked starch is 20 to 40 micrometers, preferably 25 to 35 micrometers. The average particle diameter of the cross-linked starch as used herein refers to a value (volume average particle diameter) obtained by measuring an average particle diameter of a mixture, based on laser diffraction particle size distribution analysis, and the mixture is obtained by the following steps: 500 g of a mixture of cross-linked starch and water which contains 8 mass % of the cross-linked starch is heated up to 90° C., and then is maintained at 90° C. for 5 minutes, and then is cooled to 20° C., and then is stirred at 10,000 rpm for minutes using a homomixer (TK homomixer MARKII2.5type, manufactured by PRIMIX Corporation).

Also, the cross-linked starch has preferably the following characteristic: the viscosity of the mixture obtained by heating a mixture of cross-linked starch and water which contains 8 mass % of the cross-linked starch to 90° C., then maintaining at 90° C. for 5 minutes, then cooling to 20° C., and then stirring at 10,000 rpm for 5 minutes using a homomixer is preferably 120 to 20,000 mPa·s, and more preferably 150 to 15,000 mPa·s. In the case the average particle diameter and the viscosity are within the above-mentioned ranges, water separation from vegetable or fruit can be effectively prevented by mixing the acidic oil-in-water type emulsified seasoning according to this embodiment into salad. Furthermore, the viscosity of the mixture of cross-linked starch and water which contains 8 mass % of the cross-linked starch after the stirring process at 10,000 rpm for 5 minutes using a homomixer, used in the invention, refers to a value specified by types of raw material starch, cross-linking methods, and degrees of cross-linking. For example, as the viscosity of the mixture of cross-linked starch and water which contains 8 mass % of the cross-linked starch after the above-mentioned stirring process for 5 minutes is lower, the degree of cross-linking is higher and swelling of the cross-linked starch is further prevented. Furthermore, “mixture of cross-linked starch and water” used in the invention incorporates not only an aqueous solution in which cross-linked starch is dissolved but also a water dispersion in which cross-linked starch is dispersed, and therefore, the mixture of cross-linked starch and water may be either the aqueous solution or the water dispersion.

The viscosity of the mixture of cross-linked starch and water is a value obtained from readings at the time the after-mentioned rotor turns around two cycles after the measurement starts, by using a BH viscometer under the condition that the initial temperature is 20° C. and the rotation frequency is 20 rpm, and rotor No. 1 is used when the viscosity is less than 375 mPa·s, rotor No. 2 is used when the viscosity is in the range of 375 mPa·s or more to less than 1,500 mPa·s, rotor No. 3 is used when the viscosity is in the range of 1,500 mPa·s or more to less than 3,750 mPa·s, rotor No. 4 is used when the viscosity is in the range of 3,750 mPa·s or more to less than 7,500 mPa·s, rotor No. 5 is used when the viscosity is in the range of 7,500 mPa·s or more to less than 15,000 mPa·s, and rotor No. 6 is used when the viscosity is 15,000 mPa·s or more.

In general, when the viscosity of starch is measured, a mixture of starch and water which contains 8 mass % of the starch is measured. Also, starch having a high degree of cross-linking occasionally precipitates in water, having difficulty in dispersing homogeneously, and therefore the stirring process under the above-mentioned condition is performed in the aim of measurement without variation. Furthermore, a homomixer is a stirring apparatus generally used for manufacturing foods, cosmetics, and the like for a long time, the rotation frequency of the homomixer may be adjusted.

Further, the cross-linked starch used in the acidic oil-in-water type emulsified seasoning according to this embodiment has preferably a shear resistance of 0.7 to 0.9, more preferably 0.8 to 0.9, calculated as follows. In this case, when the shear resistance is less than 0.7, the cross-linked starch has properties such that breakup and gelatinization easily occur and the surfaces of the cross-linked starch particles are easily hydrated, and thus it is difficult to obtain an effect of absorbing water separated from vegetables or fruits when mixing the oil-in-water type emulsified seasoning containing the cross-linked starch into salad. In contrast, when the shear resistance is more than 0.9, the cross-linked starch has properties such that breakup and gelatinization hardly occur and the surfaces of the cross-linked starch particles are hardly hydrated, and thus it is difficult to obtain an effect of absorbing water separated from vegetables or fruits when mixing the oil-in-water type emulsified seasoning containing the cross-linked starch into salad. That is, in the invention, “shear resistance” of the cross-linked starch is an index representing the difficulty of breakup and gelatinization and the difficulty of hydration of the surface of the cross-linked starch. In fact, when the shear resistance is high, breakup and gelatinization hardly occur, and as a result, the surface of the cross-linked starch is hardly hydrated. In contrast, when the shear resistance is low, breakup and gelatinization easily occur, and as a result, the surface of the cross-linked starch is easily hydrated.

Shear resistance can be evaluated by examining a change of the particle size before and after applying shear to the mixture of cross-linked starch and water which contains 8 mass % of the cross-linked starch, specifically, the shear resistance can be evaluated in accordance with the following procedures. Furthermore, “applying shear” used in the invention refers to applying a mechanical shear process.

procedures: At first, the particle diameter of the cross-linked starch before applying shear is measured. In fact, 500 g of a mixture of the cross-linked starch and water, which comprises 8 mass % of the cross-linked starch, is heated up to 90° C., and then is maintained at 90° C. for 5 minutes, and then is cooled to 20° C., and then is stirred with a vertical mixer (Kitchenaid, stand mixer, type name KSM5, which a wire whip is attached to) on scale 6 for 3 minutes to obtain a resulting mixture, and a value (volume average particle diameter) A is measured for the cross-linked starch in the resulting mixture by laser diffraction particle size distribution analysis. Next, the particle diameter of the cross-linked starch in the obtained mixture of the cross-linked starch and water after applying the shear is measured. In fact, the obtained mixture of the cross-linked starch and water comprising 8 mass % of the cross-linked starch is stirred at 10,000 rpm for 5 minutes using TK homomixer MARKII2.5type (manufactured by PRIMIX Corporation) to obtain a resulting mixture, and a value (volume average particle diameter) B is measured for the cross-linked starch in the resulting mixture by laser diffraction particle size distribution analysis. Subsequently, shear resistance is obtained by the following calculating formula.

shear resistance=B/A

In the case the shear resistance is within the above-mentioned range, the acidic oil-in-water type emulsified seasoning can absorb water separated from vegetables or fruits when mixing the acidic oil-in-water type emulsified seasoning into salad. Furthermore, the shear resistance used in the invention refers to a value specified by types of raw material starch, cross-linking methods, and further degrees of cross-linking. For example, as the shear resistance is higher, the cross-linking to prevent swelling of the starch particles is stronger.

The cross-linked starch which meets the above-mentioned conditions is for example, trade name “Farinex VA70WM” (manufactured by Matsutani Chemical Industry, Co., Ltd.) and trade name “Foodstarch HR-7” (manufactured by Matsutani Chemical Industry, Co., Ltd.), and the like.

Also, in order to exercise excellent effect of absorbing water separated from vegetables or fruits, the content of the cross-linked starch in the acidic oil-in-water type emulsified seasoning according to this embodiment is preferably 0.1 to 15 mass % of the acidic oil-in-water type emulsified seasoning, more preferably 1 to 10 mass %.

Furthermore, the content of the above-mentioned cross-linked starch used in the invention is a value converted as an anhydrous substance. In fact, not only the above-mentioned mixture of the cross-linked starch and water containing 8 mass % of the cross-linked starch, but also the content of the cross-linked starch in the acidic oil-in-water type emulsified seasoning, described above, are values converted as anhydrous substances.

### 1.2. Other Components

The acidic oil-in-water type emulsified seasoning according to this embodiment may comprise oils and fats (edible oils and fats) and egg yolk. The content of oils and fats in the acidic oil-in-water type emulsified seasoning according to this embodiment is 10 to 70 mass %, and in order to manufacture the acidic oil-in-water type emulsified seasoning according to this embodiment being low-calorie, the oils and fats content is preferably 10 to 40 mass %, more preferably 10 to 35 mass %. Also, the content of the egg yolk in the acidic oil-in-water type emulsified seasoning according to this embodiment is preferably 5 to 50 mass % (more preferably 10 to 40 mass %) on raw egg yolk basis.

As described later, the acidic oil-in-water type emulsified seasoning according to this embodiment may be manufactured by emulsifying aqueous phase and oil phase with an emulsifier.

An aqueous phase component of the acidic oil-in-water type emulsified seasoning according to this embodiment is not particularly limited, but including in addition to water, for example, egg yolk, vinegars (fermented vinegars), salts (sodium chloride), seasonings, carbohydrates, spices, colorings and flavorings, and one or more of these may be used either individually or in combination. Examples of the egg yolk are not particularly limited unless being used generally for edible use, but including, for example, in addition to raw egg yolk, egg yolk obtained by treating raw egg yolk with one or more process including sterilization process, refrigeration process, drying process such as spray drying or freeze drying, enzymatic process with phospholipase A1, phospholipase A2, phospholipase C, phospholipase D, protease, and the like, desugaring process with yeast, glucoseoxidase, and the like, decholesterolling process such as supercritical carbon dioxide process and the like, mixing process with salt or carbohydrates, and one or more of these may be used either individually or in combination.

An oil phase component of the acidic oil-in-water type emulsified seasoning according to this embodiment is mainly oils and fats (edible oils and fats), and examples of the oils and fats include, for example, edible vegetable oil (for example, rapeseed oil, soybean oil, safflower oil, sunflower oil, corn oil, olive oil, grape seed oil, sesame oil, cotton seed oil, perilla seed oil, linseed oil), fish oil, liver oil, further, ester-exchanged oils and fats, and oils and fats comprising mainly diglycerides, and one or more of these may be used either individually or in combination.

Also, an emulsifier which may be used in the acidic oil-in-water type emulsified seasoning according to this embodiment is appropriately selected based on the use, including for example, in addition to egg yolk described above, egg yolk lecithin, milk proteins, soybean proteins, monoglycerides, monoglyceride derivatives, sucrose fatty acid esters, sorbitan fatty acid esters, glycerin fatty acid esters, propylene glycol fatty acid esters, calcium stearoyl lactate, and vegetable lecithin, and one or more of these may be used either individually or in combination.

### 1.3. Particle Size Distribution and Viscosity

A particle size distribution of the acidic oil-in-water type emulsified seasoning according to this embodiment, measured by using a laser diffraction particle size analyzer, may comprise a first peak being present in the range of 0.5 to 5 micrometers and a second peak being present in the range of 20 to 80 micrometers. As used herein, the position of the “peak” refers to a vertex of a “mountain” being present in the particle size distribution.

In the acidic oil-in-water type emulsified seasoning according to this embodiment, a first particle may be an emulsion particle and a second particle may be a cross-linked starch. In this instance, water-absorbing effect of the acidic oil-in-water type emulsified seasoning according to this embodiment can be enhanced. Also, the emulsion particles are present between the cross-linked starch particles to form a close packing condition, and therefore, the acidic oil-in-water type emulsified seasoning can obtain a moderate sense of volume. The first peak depends on the size of the emulsion particles and the size of the emulsion particles can be adjusted by setting clearance condition, pressure, and the like in the emulsification apparatus used in accordance with common methods. The second peak depends on the size of the cross-linked starch, and in the invention, the second peak can be present in the range of 20 to 80 micrometers by using the cross-linked starch such that the average particle diameter of the cross-linked starch in the above-mentioned mixture of cross-linked starch and water containing 8 mass % of the cross-linked starch is 20 to 40 micrometers.

The viscosity of the acidic oil-in-water type emulsified seasoning according to this embodiment is preferably 20,000 to 1,000,000 mPa·s, more preferably 30,000 to 4,000,000 mPa·s, still more preferably 30,000 to 3,000,000 mPa·s, due to the ease of mixing with foodstuffs. The viscosity of an acidic oil-in-water type emulsified seasoning used in the invention refers to a value obtained from readings at the time a rotor turns around two cycles after the measurement starts, by using a BH viscometer under the condition that the initial temperature is 20° C. and the rotation frequency is 2 rpm, and rotor No. 2 is used when the viscosity is less than 15,000 mPa·s, rotor No. 3 is used when the viscosity is in the range of 15,000 mPa·s or more to less than 37,500 mPa·s, rotor No. 4 is used when the viscosity is in the range of 37,500 mPa·s or more to less than 75,000 mPa·s, rotor No. 5 is used when the viscosity is in the range of 75,000 mPa·s or more to less than 150,000 mPa·s, rotor No. 6 is used when the viscosity is in the range of 150,000 mPa·s or more to less than 375,000 mPa·s, and rotor No. 7 is used when the viscosity is 375,000 mPa·s or more.

### 1.4. Function and Effect

Since the acidic oil-in-water type emulsified seasoning comprises a cross-linked starch, the content of oils and fats is 10 to 70 mass %, the viscosity is 20,000 to 1,000,000 mPa·s, and the first peak is present in the range of 0.5 to 5 micrometers and the second peak is present in the range of 20 to 80 micrometers in the particle size distribution of the acidic oil-in-water type emulsified seasoning measured by using a laser diffraction particle size analyzer, separation of water from foodstuffs can be effectively prevented.

In general, the viscosity of the acidic oil-in-water type emulsified seasoning can be enhanced by adding thickener and the like to the acidic oil-in-water type emulsified seasoning, and as the viscosity of the acidic oil-in-water type emulsified seasoning is higher, the effect of the acidic oil-in-water type emulsified seasoning to prevent separation of water from vegetable salad or fruit salad is higher. However, the acidic oil-in-water type emulsified seasoning may have a heavy or gooey texture due to the addition of thickener and the like, and eventually the commodity value may be impaired. On the other hand, the acidic oil-in-water type emulsified seasoning, in spite of using the cross-linked starch having a low viscosity when being dispersed in water, can prevent separation of water from salad such as vegetable salad or fruit salad, and therefore the acidic oil-in-water type emulsified seasoning have good texture, in comparison with acidic oil-in-water type emulsified seasonings with a thickener with high viscosity.

### 2. Method for Manufacturing Acidic Oil-in-Water Type Emulsified Seasoning

A method for manufacturing an acidic oil-in-water type emulsified seasoning according to this embodiment may comprise mixing a aqueous phase which comprises egg yolk and the above-mentioned certain cross-linked starch and preferably has the viscosity of 100 to 2,000 mPa·s, and an oil phase which preferably has the viscosity of 10 to 200 mPa·s. In this instance, the aqueous phase and the oil phase comprise the components explained in the above-mentioned column “1.3. Other Components”, respectively, and the each viscosity of the aqueous phase and the oil phase is a value measured before emulsification. Also, in this instance, since the aqueous phase comprises the cross-linked starch, the emulsion particles consisting of oil droplets are present between the cross-linked starch to form a close packing condition, accordingly, the condition can contribute to the formation of the acidic oil-in-water type emulsified seasoning with a moderate sense of volume.

### 3. Salad

A salad according to another embodiment comprises the above-mentioned acidic oil-in-water type emulsified seasoning and at least one of a vegetable and a fruit. Examples of the salad according to this embodiment include, for example, potato salad, vegetable salad, pasta salad, egg salad, fruit salad, and the like, and the salad according to this embodiment is usually manufactured by dressing foodstuffs and the above-mentioned acidic oil-in-water type emulsified seasoning.

That is, water separates from the salad comprising at least one of a vegetable and a fruit as time passes, and the salad comprising above-mentioned acidic oil-in-water type emulsified seasoning have an excellent function and effect to prevent separation of water effectively to maintain the appearance and taste of the salad.

The content of the acidic oil-in-water type emulsified seasoning in the salad according to this embodiment is preferably 10 to 90 mass %.

### 4. Examples

The invention is further described below by way of examples.

Note that the invention is not limited to the following examples.

### 4.1. Example 1

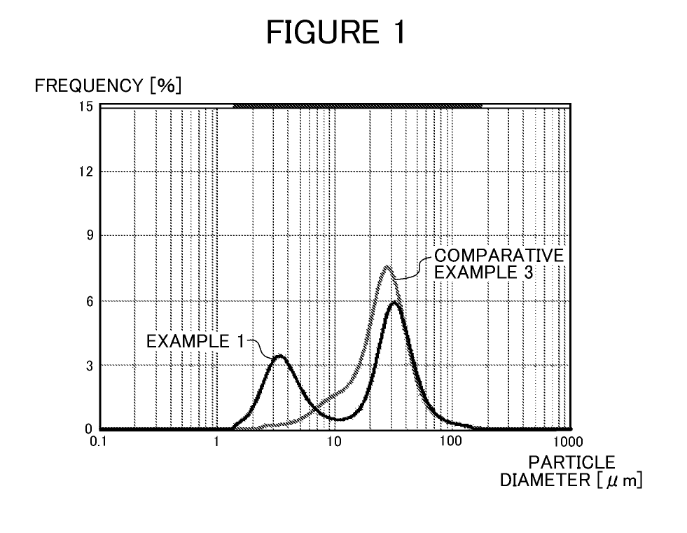

10 kg of vinegars, 43 kg of pure water, 2 kg of salt, and 5 kg of cross-linked starch made from waxy corn starch as a raw material (commercially available under the trade name “Farinex VA70WM”, manufactured by Matsutani Chemical Industry, Co., Ltd.) were mixed with a mixer to homogenize, and then heated up to 95° C. The mixture was cooled to 20° C., and then 10 kg of egg yolk containing 10 mass % of salt was mixed to manufacture aqueous phase (viscosity: 210 mPa·s), and next oil phase consisting of 30 kg of salad oil (viscosity: 30 mPa·s) was added and then preliminary emulsification was performed. The obtained preliminary-emulsified product was emulsified with a colloid mill to manufacture semi-solid salad dressing (an acidic oil-in-water type emulsified seasoning) of Example 1. The viscosity of the semi-solid salad dressing of Example 1 is 22, 500 mPa·s (measured by BH viscometer, manufactured by Toki Sangyo Co., Ltd.). Also, the particle size distribution of the semi-solid salad dressing of Example 1 was measured by using a laser diffraction particle size analyzer, and the particle size distribution having a first peak at the particle size of 3.6 micrometers and a second peak at the particle size of 30 micrometers, was obtained (see FIG. 1). In addition, A value (volume average particle diameter) was 39.3 micrometers, B value (volume average particle diameter) was 29.8 micrometers, shear resistance (A/B) was 0.8, and in this instance, the A value and the B value were measured for the cross-linked starch used in Example 1 in accordance with column “1.2. Cross-linked Starch”.

Also, the viscosity of the after-mentioned resulting mixture (water dispersion liquid containing 8 mass % of the cross-linked starch) was 13,000 mPa·s and the average particle diameter of the cross-linked starch being present in the resulting mixture was 29.8 micrometers. Note that the resulting mixture was obtained by the following process: a mixture of the cross-linked starch and water which contains 8 mass % of the cross-linked starch used in Example 1 was prepared, and was heated up to 90° C., and then was maintained at 90° C. for 5 minutes, and then was cooled to 20° C., and then was stirred at 10,000 rpm for 5 minutes using TK homomixer MARKII2.5type (manufactured by PRIMIX Corporation) to obtain the resulting mixture. Furthermore, average particle diameters of oil droplets, average particle diameters of cross-linked starch, and particle size distribution of semi-solid salad dressings, measured in Example 1 and other examples and comparative examples to be hereinafter described, were measured by using a particle size analyzer, MT3300EXII (manufactured by Nikkiso, Ltd.). The above-mentioned particle size distribution of Example 1 demonstrates the oil droplets and the cross-linked starch particles coexist in the semi-solid salad dressing of Example 1.

### 4.2. Example 2

A semi-solid salad dressing (acidic oil-in-water type emulsified seasoning) of Example 2 was manufactured in accordance with the same procedure as described in Example 1, except the content of oils and fats was 40 kg, the content of the cross-linked starch was 4.5 kg, and the content of the pure water was 33.5 kg. The viscosity of the semi-solid salad dressing of Example 2 was 265,000 mPa·s. Also, a particle size distribution having a first peak at the particle diameter of 2.3 micrometers and a second peak at the particle diameter of 31 micrometers was obtained by measuring the particle size distribution of the semi-solid salad dressing of Example 2 with the laser diffraction particle size analyzer.

### 4.3. Example 3

A semi-solid salad dressing (acidic oil-in-water type emulsified seasoning) of Example 3 was manufactured in accordance with the same procedure as described in Example 1, except cross-linked starch (trade name “Foodstarch HR-7”, manufactured by Matsutani Chemical Industry, Co., Ltd.) made from tapioca starch as a raw material, was added in place of the cross-linked starch (trade name “Farinex VA70WM”) used in Example 1, the additive amount of cross-linked starch was 6 kg, and the content of the pure water was 42 kg. The viscosity of the semi-solid salad dressing of Example 3 was 110,000 mPa·s. Also, a particle size distribution having a first peak at the particle diameter of 2.0 micrometers and a second peak at the particle diameter of 78 micrometers was obtained by measuring the particle size distribution of the semi-solid salad dressing of Example 3 with the laser diffraction particle size analyzer. Furthermore, A value (volume average particle diameter) was 29.3 micrometers, B value (volume average particle diameter) was 27.1 micrometers, shear resistance (A/B) was 0.9, and in this instance, the A value and the B value were measured for the cross-linked starch used in Example 3 in accordance with column “1.2. Cross-linked Starch”.

Also, the viscosity of the after-mentioned resulting mixture (water dispersion liquid containing 8 mass % of the cross-linked starch) was 150 mPa·s and the average particle diameter of the cross-linked starch being present in the resulting mixture was 27.1 micrometers. Note that the resulting mixture was obtained by the following process: a mixture of the cross-linked starch and water which contains 8 mass % of the cross-linked starch used in Example 3 was prepared, and was heated up to 90° C., and then was maintained at 90° C. for 5 minutes, and then was cooled to 20° C., and then was stirred at 10,000 rpm for 5 minutes using TK homomixer to obtain the resulting mixture.

### 4.4. Comparative Example 1

A semi-solid salad dressing (acidic oil-in-water type emulsified seasoning) of Comparative Example 1 was manufactured in accordance with the same procedure as described in Example 1, except gelatinized starch made from waxy corn starch as a raw material was added in place of the cross-linked starch in the method for manufacturing the semi-solid salad dressing of Example 1. The viscosity of the semi-solid salad dressing of Comparative Example 1 was 94,000 mPa·s. Also, a particle size distribution of the semi-solid salad dressing of Comparative Example 1, measured by using the laser diffraction particle size analyzer, shows only a first peak at the particle diameter of 1.9 micrometers.

Furthermore, the viscosity of the after-mentioned resulting mixture (water dispersion liquid containing 8 mass % of the cross-linked starch) was 44,000 mPa·s, and the average particle diameter of the gelatinized starch being present in the resulting mixture was 8.7 micrometers. Note that the resulting mixture was obtained by the following process: a mixture of the gelatinized starch and water which contains 8 mass % of the gelatinized starch used in Comparative Example 1 was prepared, and was heated up to 90° C., and then was maintained at 90° C. for 5 minutes, and then was cooled to 20° C., and then was stirred at 10,000 rpm for 5 minutes using TK homomixer to obtain the resulting mixture. Moreover, it is understandable that the semi-solid salad dressing of Comparative Example 1 consists of only oil droplets (emulsion particles), judging from the particle size distribution of the above-mentioned semi-solid salad dressing of Comparative Example 1.

### 4.5. Comparative Example 2

Mayonnaise (acidic oil-in-water type emulsified seasoning) of Comparative Example 2 was manufactured in accordance with the same procedure as described in Example 1, except cross-linked starch (trade name “Farinex VA70WM”) made from tapioca starch as a raw material, was added in place of the cross-linked starch of the trade name “National 104” in the method for manufacturing the semi-solid salad dressing of Example 1. The viscosity of the semi-solid salad dressing of Comparative Example 2 was 100,000 mPa·s. Furthermore, A value (volume average particle diameter) was 28.1 micrometers, B value (volume average particle diameter) was 28.4 micrometers, shear resistance (A/B) was 1, and in this instance, the A value and the B value were measured for the cross-linked starch used in Comparative Example 2 in accordance with column “1.2. Cross-linked Starch”.

Furthermore, the viscosity of the after-mentioned resulting mixture (water dispersion liquid containing 8 mass % of the cross-linked starch) was 100 mPa·s, and the average particle diameter of the cross-linked starch being present in the resulting mixture was 28.4 micrometers. Note that the resulting mixture was obtained by the following process: a mixture of the gelatinized starch and water which contains 8 mass % of the gelatinized starch used in Comparative Example 2 was prepared, and was heated up to 90° C., and then was maintained at 90° C. for 5 minutes, and then was cooled to 20° C., and then was stirred at 10,000 rpm for 5 minutes using TK homomixer to obtain the resulting mixture.

### 4.6. Comparative Example 3

A semi-solid salad dressing (acidic oil-in-water type emulsified seasoning) of Comparative Example 3, which was a crude emulsified product was manufactured in accordance with the same procedure as described in Example 1, except the emulsification with a colloid mill was not performed in the method for manufacturing the semi-solid salad dressing of Example 1. The viscosity of the semi-solid salad dressing of Comparative Example 3 was 1,600 mPa·s. Also, a particle size distribution, which was obtained by measuring the particle size distribution of the semi-solid salad dressing of Comparative Example 3 with the laser diffraction particle size analyzer, shows only a second peak at the particle diameter of 28 micrometers (See FIG. 1). That is, in Comparative Example 3, since the size of the emulsion particles is about the same as the size of the cross-linked starch, the only one peak appears at the particle diameter of 28 micrometers.

### 4.7. Test Example 1

Salad was manufactured in accordance with the following procedure with using the semi-solid salad dressings manufactured in Examples 1 to 3 and Comparative Examples 1 to 3, respectively. Specifically, 100 parts of julienne cabbage, 100 parts of the each semi-solid salad dressing, and 15 parts of water were mixed to manufacture coleslaw salad, and 60 g of each salad was put into a plastics container with a lid made of gauze (the container was weighed in advance) and was placed in the fridge overnight with the lid covered. Then, the each container with the salad was taken from the fridge, and was kept at 20° C., and then the lid was opened and the gaze was pulled up to remove water, and the salad was removed from the container, and then the container was weighted to calculate the water separation rate.

Water Separation Rate (%)={(mass of the container after 24 hours (g))−(tare mass of the container (g))/(mass of the container containing salad (g))}×100

TABLE 1

| | | | | | Com- | Com- |
|---|---|---|---|---|---|---|
| | | | | | parative | parative |
| | Exam- | Exam- | Exam- | Comparative | Exam- | Exam- |
| | ple 1 | ple 2 | ple 3 | Example 1 | ple 2 | ple 3 |
| Water | 1.18 | 2.02 | 1.70 | 3.61 | 4.19 | 3.12 |
| Separation | | | | | | |
| Rate (%) | | | | | | |

It is understandable from the results shown in Table 1 that the salad using the semi-solid salad dressings manufactured in Examples 1 to 3 respectively prevented water separation effectively. Also, all the semi-solid salad dressings manufactured in Examples 1 to 3 had good texture.

1. An acidic oil-in-water type emulsified seasoning comprising
a cross-linked starch,
wherein the content of oils and fats is 10 to 70 mass %,
wherein the viscosity is 20,000 to 1,000,000 mPa·s,
wherein a first peak is present in the range of 0.5 to 5 micrometers and a second peak is present in the range of 20 to 80 micrometers in a particle size distribution of the acidic oil-in-water type emulsified seasoning measured by using a laser diffraction particle size analyzer, and
wherein the cross-linked starch has the following characteristics:
the viscosity of a mixture of the cross-linked starch and water prepared under the following condition is 120 to 20,000 mPa·s; and
the average particle diameter of the cross-linked starch being present in the mixture is 20 to 40 micrometers.
Condition: a mixture of the cross-linked starch and water comprising 8 mass % of the cross-linked starch is heated up to 90° C., and then is maintained at 90° C. for 5 minutes, and then is cooled to 20° C., and then is stirred with a homomixer at 10,000 rpm for 5 minutes.

2. The acidic oil-in-water type emulsified seasoning according to claim 1,
wherein the first peak is present in the range of 1 to 3 micrometers.

3. The acidic oil-in-water type emulsified seasoning according to claim 1,
wherein the cross-linked starch has a shear resistance of 0.7 to 0.9 calculated from the following procedures (1) to (3).
procedure (1): A mixture of the cross-linked starch and water comprising 8 mass of the cross-linked starch is heated up to 90° C., and then is maintained at 90° C. for 5 minutes, and then is cooled to 20° C., and then is stirred with a vertical mixer (to which a wire whip is attached) on scale 6 for 3 minutes to obtain a resulting mixture, and a volume average particle diameter A of the cross-linked starch in the resulting mixture is measured by laser diffraction particle size distribution analysis.
procedure (2): The mixture of the cross-linked starch and water comprising 8 mass % of the cross-linked starch obtained by procedure (1) is stirred with a homomixer at 10,000 rpm for 5 minutes to obtain a resulting mixture, and a volume average particle diameter B of the cross-linked starch in the resulting mixture is measured by laser diffraction particle size distribution analysis.
procedure (3): A shear resistance is calculated from the following calculating formula.
shear resistance=B/A

4. A salad comprising the acidic oil-in-water type emulsified seasoning according to any one of claims 1 to 3 and at least one of a vegetable and a fruit.

5. A method for manufacturing the acidic oil-in-water type emulsified seasoning according to any one of claims 1 to 3 comprising mixing a water phase which comprises egg yolk and the cross-linked starch and an oil phase.
